(19) United States
(12) Patent Application Publication
(10) Pub. No.: US 2024/0146387 A1
(43) Pub. Date: May 2, 2024

(54) COMPUTER IMPLEMENTED METHOD, MEASUREMENT APPLICATION DEVICE, AND NON-TRANSITORY COMPUTER READABLE MEDIUM

(71) Applicant: ROHDE & SCHWARZ GMBH & CO. KG, Munchen (DE)

(72) Inventors: Sven BARTHEL, Chemnitz (DE); Benjamin SCHNEIDER, Chemnitz (DE)

(21) Appl. No.: 18/050,127

(22) Filed: Oct. 27, 2022

(51) Int. Cl. H04B 7/12

(52) U.S. Cl. CPC H04B 7/12

(57) ABSTRACT

The present disclosure provides a computer implemented method for estimating characteristics of a circuit, the method comprising recording at least one of a gain response and a phase response of the circuit, and determining at least one characteristic parameter of at least one of the gain response and the phase response of the circuit. The present disclosure further provides a respective measurement application device, and a respective non-transitory computer readable medium.

### TECHNICAL FIELD

The disclosure relates to a computer implemented method, a measurement application device, and a non-transitory computer readable medium.

### BACKGROUND

Although applicable to any type of measurement application device, the present disclosure will mainly be described in conjunction with Oscilloscopes.

During development of electronic devices, circuits, like filters, of the electronic devices are usually first dimensioned mathematically and are afterwards built as circuit. In other applications, an unknown circuit is to be analyzed.

Accordingly, there is a need for verifying the characteristics of a real implementation of a circuit that is mathematically designed or is a circuit of an unknown type.

### SUMMARY

The above stated problem is solved by the features of the independent claims. It is understood, that independent claims of a claim category may be formed in analogy to the dependent claims of another claim category.

Accordingly, it is provided:

A computer implemented method for estimating characteristics of a circuit, the method comprising recording at least one of a gain response and a phase response of the circuit, and determining at least one characteristic parameter of at least one of the gain response and the phase response of the circuit.

Further, it is provided:

A measurement application device comprising a signal acquisition interface configured to record at least one of a gain response and a phase response of a circuit, and a signal processor configured to determine at least one characteristic parameter of at least one of the gain response and the phase response of the circuit.

Further, it is provided:

A non-transitory computer readable medium comprising instructions that when executed by a processor cause the processor to record at least one of a gain response and a phase response of a circuit, and determine at least one characteristic parameter of at least one of the gain response and the phase response of the circuit.

The present disclosure is based on the finding that a mathematically determined circuit e.g., a filter, that is calculated and then implemented as electric circuit, in reality may exhibit characteristics that deviate from those of the intended or calculated circuit. Further, sometimes existing circuits, like filters, need to be classified without knowing the exact kind of circuit that a user has at hand.

The present disclosure, therefore, provides a method and a measurement application device that both allow determining characteristic parameters of electric circuits based on a measurement performed with the circuit.

With the method and the measurement application device, at least one of a gain response and a phase response of the circuit may be recorded or measured.

These two specific types of responses usually allow drawing detailed conclusions about the circuit at hand that is to be analyzed. In this disclosure, the circuit may also be referred to as device under test, or DUT. Such a DUT may be analyzed, for example, with a measurement application device according to the present disclosure.

It is understood, that such a measurement application device may comprise or may be implemented at least in part in or may be an oscilloscope, a spectrum analyzer, a vector network analyzer, and a computer implemented measurement application program, but is not limited to these implementations.

The at least one characteristic parameter of the circuit is determined based on the recorded response i.e., the gain response and/or the phase response, of the circuit.

After determining characteristic parameters for the circuit, a user may determine if the circuit exhibits the required properties or may determine the type of circuit, especially the type of filter, of the circuit at hand. The user may, for example, compare the determined characteristic parameters with characteristic parameters of known circuits to at least approximate the type of circuit at hand.

The measurement application device may comprise any device that may be used in a measurement application to acquire the analog input signal. Such a measurement application device may comprise, for example, a signal acquisition device, an oscilloscope, especially a digital oscilloscope, or a vector network analyzer. Of course, a measurement application device may also comprise additional functionality, like a signal generation functionality, as will be explained in more detail below.

In embodiments, the measurement application device may also comprise pure data acquisition devices that are capable of acquiring the analog input signal and provide the acquired analog input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface.

It is understood, that the signal processor of the measurement application device may be provided as at least one of a dedicated processing element e.g., a processing unit, a microcontroller, a field programmable gate array, FPGA, a complex programmable logic device, CPLD, an application specific integrated circuit, ASIC, or the like. The signal processor may at least in part also be provided as a computer program product comprising computer readable instructions that may be executed by a processing element. In a further embodiment, the signal processor may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to the computer implemented method for estimating characteristics of a circuit can be combined in all variations with each other and the disclosure of the description is not limited to the claim dependencies as specified in the claim set. In addition, the features disclosed herein for any one of the embodiments of the method of claim 1, may also be implemented in the measurement application device and the non-transitory computer readable medium.

In an embodiment, which can be combined with all other embodiments of the computer implemented method mentioned above or below, the method may further comprise determining an ideal transfer function for the circuit based on the determined at least one characteristic parameter.

Determining an ideal transfer function refers to not only determining characteristic parameters of the circuit at hand that allow comparing the characteristic parameters with parameters of known circuits.

Instead, an ideal transfer function may be determined for the characteristic parameters of the circuit.

Ideal in this regard refers to a mathematical representation of the transfer function that produces a gain response and/or a phase response as similar as possible to the recorded gain response and/or phase response.

It is understood, that the mathematical representation not necessarily needs to produce a transfer function that is identical to the recorded gain response and/or phase response. Instead, a similarity measure or similarity value may be determined for possible candidate mathematical representations and the mathematical representation with the best similarity measure or similarity value may be selected.

It is understood, that a database comprising predetermined ideal transfer functions may be provided and the ideal transfer function may be chosen from one of the transfer functions stored the database. In embodiments, a user interface may be provided that allows a user to select an ideal transfer function and/or input further ideal transfer functions.

The ideal transfer functions may, for example, be provided as mathematical formula(s) with respective variables. These variables may be filled based on the at least one characteristic parameter.

In a further embodiment, which can be combined with all other embodiments of the computer implemented method mentioned above or below, the ideal transfer function may comprise a filter function that matches the determined at least one characteristic parameter.

Especially filter circuits are often designed mathematically and then implemented as real circuit. Therefore, a filter function as ideal filter function may be chosen and parametrized based on the determined at least one characteristic parameter.

In another embodiment, which can be combined with all other embodiments of the computer implemented method mentioned above or below, determining the ideal transfer function may comprise determining, especially calculating, at least one parameter of the filter function based on the determined at least one characteristic parameter.

As indicated above, the filter function may be provided as at least one mathematical formula. Such a formula may comprise multiple parameters or variables. The parameters of the formula may be set or adapted according to the at least one characteristic parameter that is determined for the circuit.

In embodiments, the parameters may be read directly from the graph of the gain response and/or the phase response. In other embodiments, at least one of the parameters may also be estimated or fitted. To this end, a respective artificial intelligence-based algorithm may be provided.

In embodiments, the variables of the filter function may be determined by polynomial interpolation or polynomial regression or any other type of fitting algorithm. In embodiments, an artificial intelligence-based algorithm may be used to determine the parameters of the filter function.

In a further embodiment, which can be combined with all other embodiments of the computer implemented method mentioned above or below, the at least one parameter of the filter function may comprise at least one of a filter type, an S-Parameter, and an equivalent circuit.

The parameters of the filter function that are determined not necessarily need to refer only to the variables of a mathematical filter function. Instead, the parameters may also refer to a specific filter type, for example, a FIR filter, an IIR filter, a digital filter, and a discrete filter.

In embodiments, the filter function may comprise multiple sub-functions. For example, a band pass filter may be implemented by a low pass filter and a high pass filter.

Further, S-Parameters for the circuit may be determined based on the recorded gain response and/or phase response to characterized the circuit. The S-Parameters may then be used to define e.g., variables of the selected filter function.

In embodiments, these parameters may—as indicated above—be determined by an artificial intelligence-based algorithm. Such an artificial intelligence-based algorithm may, for example, be trained to determine a type of filter based on a graphical representation of the recorded gain response and/or phase response.

In embodiments, a user may be provided with a display of the recorded at least one of the gain response and the phase response of the circuit, and the gain response and the phase response of the filter function with the determined parameters.

An artificial intelligence-based algorithm may also be trained to determine an equivalent circuit for the DUT or circuit to be analyzed.

In another embodiment, which can be combined with all other embodiments of the computer implemented method mentioned above or below, recording at least one of a gain response and a phase response of the circuit may comprise recording a bode plot for the circuit.

A bode plot may be recorded by a measurement application device, like an oscilloscope, for the circuit and may, therefore, easily be created.

The bode plot may comprise the gain response and the phase response of the circuit for determination of the characteristic parameters in the bode plot.

In a further embodiment, which can be combined with all other embodiments of the computer implemented method mentioned above or below, the at least one characteristic parameter may comprise at least one of a frequency of the 3 dB cutoff frequency point, an overshoot amplitude, an overshoot frequency, a slope, especially comprising two amplitude and frequency tuples, at least one pole, and at least one zero point.

The characteristic parameters that may be determined for the circuit may comprise any parameter that may be read from the gain response and phase response e.g., from the bode plot.

In embodiments, the characteristic parameters that are determined may comprise the frequency of the 3 dB cutoff frequency point in the bode plot. Another characteristic parameter may comprise an overshoot amplitude. The overshoot amplitude is the amplitude that the curve in the bode plot raises over the 0 dB. Of course, the frequency of the maximum of the overshoot amplitude may also be determined as characteristic parameter.

A circuit that comprises a filter, will usually comprise a linear section, which may be characterized by the slope, especially, by indicating two amplitude and frequency tuples that define a start point and an end point of the linear section.

Additional parameters that may be determined comprise at least one pole and at least one zero point.

In an embodiment, which can be combined with all other embodiments of the computer implemented method mentioned above or below, determining the at least one characteristic parameter may comprise automatically detecting points that characterize the respective characteristic parameter in the recorded at least one of the gain response and the phase response of the circuit.

The characteristic parameters may be automatically detected in the gain response and phase response e.g., in the bode plot. To this end, the bode plot may be automatically analyzed for the occurrence of any of the characteristic parameters mentioned herein.

The automatic analysis may be performed via respective search algorithms. As will be explained in more detail below, the −3 dB frequency may, for example, be identified by searching for the frequency at which the gain of the circuit is −3 dB. The overshoot amplitude and frequency may be determined by searching for the maximum value of the recorded gain response. The same applies to identifying the slope of the linear section, wherein two points are identified in the graph of the recorded gain that are connected by a linear section of the graph. It is understood, that the term “linear” in this regard may be seen as comprising a linearity margin i.e., that variations of the slope up to a specific limit are still comprised in the “linear” section.

In a further embodiment, which can be combined with all other embodiments of the computer implemented method mentioned above or below, determining the at least one characteristic parameter may comprise receiving a user input that identifies points that characterize the respective characteristic parameter in the recorded at least one of the gain response and the phase response of the circuit.

It is understood, that the user interface may comprise any type of input device that may be actuated by a user. Such a user interface may comprise a user interface of the measurement application device or an external user interface. Exemplary input devices may for example comprise at least one of keys, buttons, a mouse, a keyboard, a touch panel, and a touch pad.

In embodiments, the characteristic parameters may alternatively be determined manually. To this end, the recorded gain response and phase response e.g., the bode plot, may be presented to a user and the user may mark or otherwise identify the characteristic parameters.

The manual identification may also be coupled with the manual identification of the characteristic parameters. For example, the automatically identified characteristic parameters may be indicated to a user e.g., on a respective display, and the user may manually correct the automatically identified characteristic parameters if required.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a flow diagram of an embodiment of a method according to the present disclosure;

FIG. 2 shows a block diagram of an embodiment of a measurement application device according to the present disclosure;

FIG. 3 shows a diagram of an embodiment of a bode diagram that may be used with an embodiment of a method or a measurement application device according to the present disclosure;

FIG. 4 shows a block diagram of an embodiment of an oscilloscope that may be used as an embodiment of a measurement application device according to the present disclosure; and

FIG. 5 shows a block diagram of an embodiment of another oscilloscope that may be used as an embodiment of a measurement application device according to the present disclosure.

In the figures like reference signs denote like elements unless stated otherwise.

### DETAILED DESCRIPTION OF THE DRAWINGS

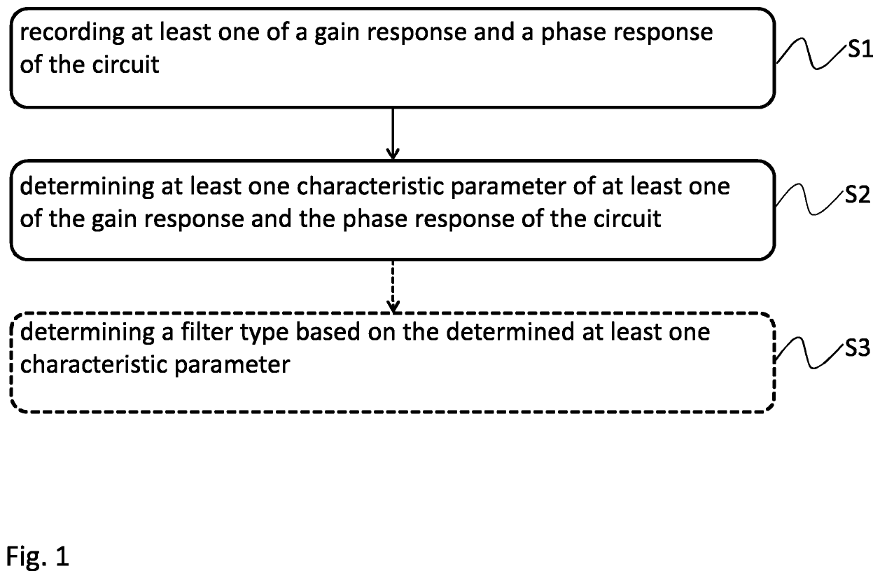

FIG. 1 shows a flow diagram of an embodiment of a method for estimating characteristics of a circuit. The method comprises recording 51 at least one of a gain response and a phase response of the circuit, and determining S2 at least one characteristic parameter of at least one of the gain response and the phase response of the circuit. As an optional step S3, the method may comprise determining an ideal transfer function for the circuit based on the determined at least one characteristic parameter. In FIG. 1, the ideal transfer function is indicated as a filter function, wherein the filter type is determined in optional step S3. Of course, not only the filter type, but also parameters of a filter function for the respective filter type may in addition be determined. Such a filter function may be determined to match the determined at least one characteristic parameter.

The parameters that may be determined of the filter function in addition to a filter type and specific variables of a filter function may, for example, comprise at least one S-Parameter or an equivalent circuit.

Recording S1 the at least one of a gain response and a phase response of the circuit may also comprise generating or recording a bode plot for the circuit. Further, the at least one characteristic parameter may comprise at least one of a frequency of the 3 dB cutoff frequency point, an overshoot amplitude, an overshoot frequency, a slope, at least one pole, and at least one zero point.

It is understood, that the characteristic parameter may be determined by automatically detecting points that characterize the respective characteristic parameter in the recorded at least one of the gain response and the phase response of the circuit. In other embodiments, the characteristic parameters may be defined by a user in the recorded at least one of the gain response and the phase response of the circuit.

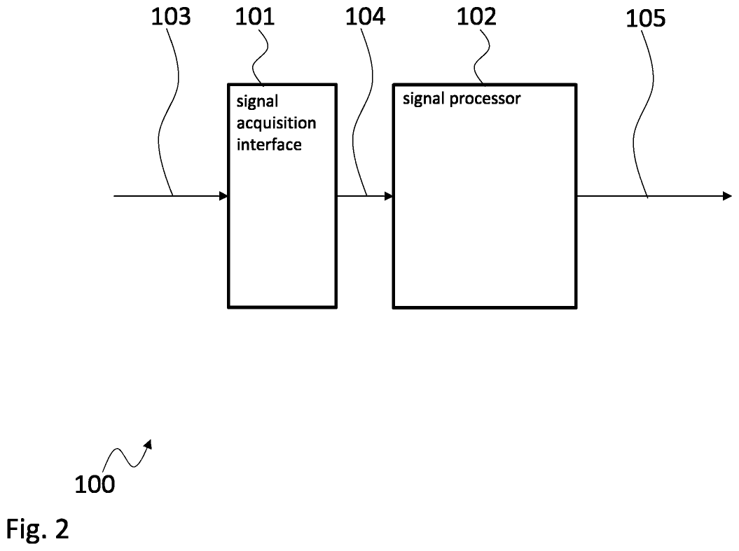

FIG. 2 shows a block diagram of an embodiment of a measurement application device 100. The measurement application device 100 comprises a signal acquisition interface 101 that is coupled to a signal processor 102.

The signal acquisition interface 101 receives a measurement signal 103 from the device under test i.e., the circuit, and records at least one of a gain and a phase response 104 of the circuit. The signal processor 102 determines at least one characteristic parameter 105 of the at least one of the gain and the phase response 104.

It is understood, that the signal acquisition interface 101 may also forward the measurement signal 103 to the signal processor 102, wherein the signal processor 102 may determine the at least one of the gain and the phase response 104.

It is understood, that the measurement application device 100 may comprise further components, like a display or user interface, that allow a user to interact with the measurement application device 100.

The measurement application device 100 may in embodiments be implemented in an oscilloscope, as will be explained in more detail below.

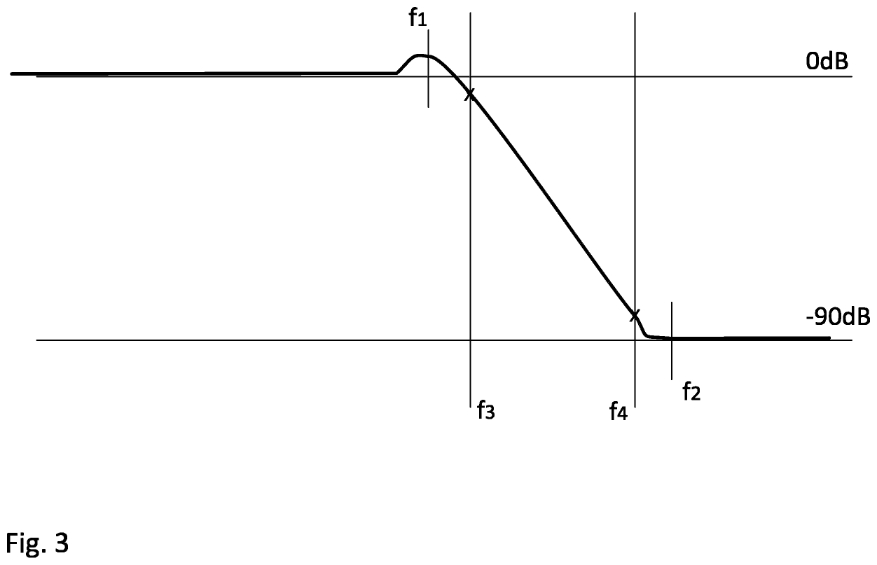

FIG. 3 shows an exemplary gain response of a bode diagram that may be used to determine at least one characteristic parameter.

As bold-line graph, the measured gain response is shown. The measured gain response starts on the left as a straight line on the 0 dB line. Shortly before a frequency f1 the overshoot section begins, with the maximum at the frequency f1. From the frequency f1, the measured gain response descends to the −90 dB line at frequency f2, wherein between frequencies f3 and f4 that are between frequencies f1 and f2 a linear section is present.

In the gain response shown in FIG. 3, multiple characteristic parameters may be determined.

For example, the f1 frequency may be determined that characterizes the maximum of the overshoot section. Further, the f2 frequency may be determined that characterizes the start of the section with the lowest gain of −90 dB.

With the frequencies f3 and f4, the slope and the size of the linear section may be determined.

With these characteristic parameters it is now possible to determine, for example, a filter type with the respective filter function, and to parametrize the filter function to provide a gain response that is as similar to the measured gain response as possible.

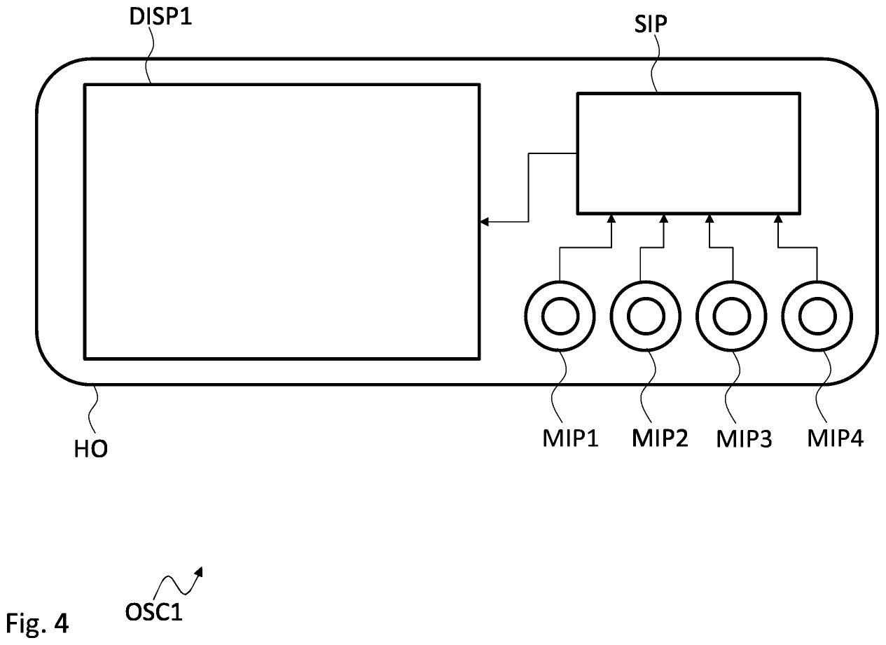

FIG. 4 shows a block diagram of an oscilloscope OSC1 that may be used with an embodiment of a differential measurement probe according to the present disclosure.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

Although not explicitly shown, it is understood, that the oscilloscope OSC1 may also comprise signal outputs. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

The signal processor SIP may, for example, execute a computer program product comprising computer readable instructions that when executed by the signal processor SIP cause the signal processor SIP to perform a method according to any one of the embodiments of the method according to the present disclosure.

Of course, the at least one of the gain and the phase response may be displayed to a user on the display DISP1, and user input may be provided to determine the characteristic parameters manually.

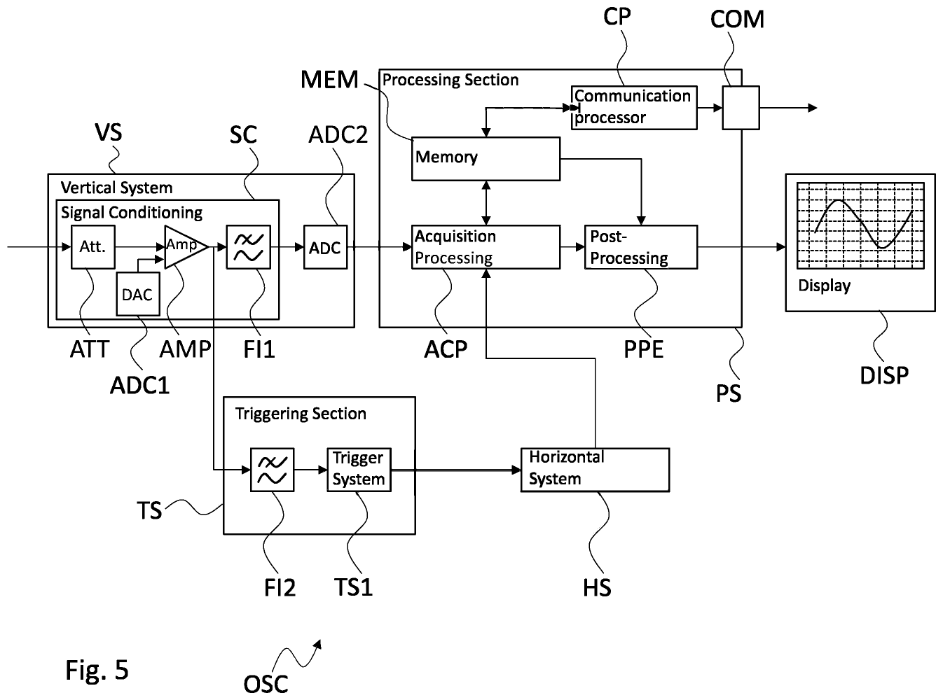

FIG. 5 shows a block diagram of an oscilloscope OSC that may be an implementation of a signal processing device according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way.

The vertical system VS mainly serves for offsetting, attenuating and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP1. The amplifier AMP1 is coupled to a filter FI1, which in the shown example is provided as a low pass filter. The vertical system VS also comprises an analog-to-digital converter ADC1 that receives the output from the filter FI1 and converts the received analog signal into a digital signal.

The attenuator ATT and the amplifier AMP1 serve to scale the amplitude of the signal to be acquired to match the operation range of the analog-to-digital converter ADC1. The digital-to-analog-converter DAC1 serves to modify the DC component of the input signal to be acquired to match the operation range of the analog-to-digital converter ADC1. The filter FI1 serves to filter out unwanted high frequency components of the signal to be acquired.

The triggering section TS operates on the signal as provided by the amplifier AMP. The triggering section TS comprises a filter FI2, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC1 and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC1.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC1 and the output of the horizontal system HS as well as to a memory MEM and a post processing element PPE.

The acquisition processing element ACP manages the acquisition of digital data from the analog-to-digital converter ADC1 and the storage of the data in the memory MEM. The acquisition processing element ACP may for example comprise a processing element with a digital interface to the analog-to-digital converter ADC2 and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

In the oscilloscope OSC, any of the processing elements may execute at least part of a computer program product comprising computer readable instructions that when executed by the processing element cause the processing element to perform a method according to any one of the embodiments of the method according to the present disclosure.

Of course, the at least one of the gain and the phase response may be displayed to a user on the display DISP, and user input may be provided to determine the characteristic parameters via a respective user interface.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

S1, S2, S3 method steps
100 measurement application device
101 signal acquisition interface
102 signal processor
103 measurement signal
104 response
105 characteristic parameter
f1-f4 characteristic frequency
OSC1 oscilloscope
HO housing
MIP1, MIP2, MIP3, MIP4 measurement input
SIP signal processing
DISP1 display
OSC oscilloscope
VS vertical system
SC signal conditioning
ATT attenuator
DAC1 analog-to-digital converter
AMP1 amplifier
FI1 filter
ADC1 analog-to-digital converter
TS triggering section
AMP2 amplifier
FI2 filter
TS1 trigger system
HS horizontal system
PS processing section
ACP acquisition processing element
MEM memory
PPE post processing element
DISP display

1. A computer implemented method for estimating characteristics of a circuit, the method comprising:
recording at least one of a gain response and a phase response of the circuit;
determining at least one characteristic parameter of at least one of the gain response and the phase response of the circuit; and
determining an ideal transfer function for the circuit based on the determined at least one characteristic parameter by choosing the ideal transfer function from a database comprising predetermined ideal transfer functions,
wherein the ideal transfer function comprises a mathematical representation of an actual transfer function, selected from the predetermined ideal transfer functions of the database, that produces a gain response and/or a phase response with a similarity measure most similar to the recorded gain response and/or phase response of the circuit.

2. (canceled)

3. The computer implemented method according to claim 1, wherein the ideal transfer function comprises a filter function that matches the determined at least one characteristic parameter.

4. The computer implemented method according to claim 3, wherein determining the ideal transfer function comprises determining at least one parameter of the filter function based on the determined at least one characteristic parameter.

5. The computer implemented method according to claim 4, wherein the at least one parameter of the filter function comprises at least one of a filter type, an S-Parameter, and an equivalent circuit.

6. The computer implemented method according to claim 1, wherein recording at least one of a gain response and a phase response of the circuit comprises recording a bode plot for the circuit.

7. The computer implemented method according to claim 1, wherein the at least one characteristic parameter comprises at least one of a frequency of the 3 dB cutoff frequency point, an overshoot amplitude, an overshoot frequency, a slope, at least one pole, and at least one zero point.

8. The computer implemented method according to claim 1, wherein determining the at least one characteristic parameter comprises automatically detecting points that characterize the respective characteristic parameter in the recorded at least one of the gain response and the phase response of the circuit.

9. The computer implemented method according to claim 1, wherein determining the at least one characteristic parameter comprises receiving a user input that identifies points that characterize the respective characteristic parameter in the recorded at least one of the gain response and the phase response of the circuit.

10. A measurement application device comprising:
a signal acquisition interface configured to record at least one of a gain response and a phase response of a circuit; and
a signal processor configured to determine at least one characteristic parameter of at least one of the gain response and the phase response of the circuit,
wherein the signal processor is further configured to determine an ideal transfer function for the circuit based on the determined at least one characteristic parameter by choosing the ideal transfer function from a database comprising predetermined ideal transfer functions,
wherein the ideal transfer function comprises a mathematical representation of an actual transfer function, selected from the predetermined ideal transfer functions of the database, that produces a gain response and/or a phase response with a similarity measure most similar to the recorded gain response and/or phase response of the circuit.

11. (canceled)

12. The measurement application device according to claim 10, wherein the ideal transfer function comprises a filter function that matches the determined at least one characteristic parameter.

13. The measurement application device according to claim 12, wherein when determining the ideal transfer function the signal processor calculates at least one parameter of the filter function based on the determined at least one characteristic parameter.

14. The measurement application device according to claim 13, wherein the at least one parameter of the filter function comprises at least one of a filter type, an S-Parameter, and an equivalent circuit.

15. The measurement application device according to claim 10, wherein the signal processor is further configured to generate a bode plot for the circuit based on the recorded at least one of the gain response and the phase response of the circuit.

16. The measurement application device according to claim 10, wherein the at least one characteristic parameter comprises at least one of a frequency of the 3 dB cutoff frequency point, an overshoot amplitude, an overshoot frequency, a slope, at least one pole, and at least one zero point.

17. The measurement application device according to claim 10, wherein when determining the at least one characteristic parameter, the signal processor is configured to automatically detect points that characterize the respective characteristic parameter in the recorded at least one of the gain response and the phase response of the circuit.

18. The measurement application device according to claim 10, wherein when determining the at least one characteristic parameter, the signal processor is configured to receive a user input that identifies points that characterize the respective characteristic parameter in the recorded at least one of the gain response and the phase response of the circuit.

19. A non-transitory computer readable medium comprising instructions that when executed by a processor cause the processor to:
record at least one of a gain response and a phase response of a circuit;
determine at least one characteristic parameter of at least one of the gain response and the phase response of the circuit; and
determine an ideal transfer function for the circuit based on the determined at least one characteristic parameter by choosing the ideal transfer function from a database comprising predetermined ideal transfer functions,
wherein the ideal transfer function comprises a mathematical representation of an actual transfer function, selected from the predetermined ideal transfer functions of the database, that produces a gain response and/or a phase response with a similarity measure most similar to the recorded gain response and/or phase response of the circuit.
